(19) United States
(12) Patent Application Publication
(10) Pub. No.: US 2017/0147422 A1
(43) Pub. Date: May 25, 2017

(54) EXTERNAL SOFTWARE FAULT DETECTION SYSTEM FOR DISTRIBUTED MULTI-CPU ARCHITECTURE

(71) Applicant: ALCATEL-LUCENT CANADA INC., Ottawa (CA)

(72) Inventor: Toby Koktan, Dunrobin (CA)

(73) Assignee: ALCATEL-LUCENT CANADA, INC.

(21) Appl. No.: 14/949,508

(22) Filed: Nov. 23, 2015

(51) Int. Cl. G06F 11/07

(52) U.S. Cl. CPC G06F 11/0757; G06F 11/0721; G06F 11/079

(57) ABSTRACT

Various exemplary embodiments relate to a method performed by a first processor for managing a second processor, wherein both processors have access to a same external memory, the method comprising: monitoring performance of the second processor by the first processor running sanity polling, wherein sanity polling includes checking the same external memory for status information of the second processor; performing thread state detection by the first processor, for threads executing on the second processor; and performing a corrective action as a result of either the monitoring or the performing.

### TECHNICAL FIELD

Various exemplary embodiments disclosed herein relate generally to computer architecture.

### BACKGROUND

“Software watchdogs” are commonly employed to detect unresponsive software. They are usually implemented in hardware whereby normally executing software may write a heartbeat value to a hardware device periodically. Normally executing software may include that which is not stuck in an endless unresponsive loop, or a processor that is hung. Failure to write the heartbeat may cause the hardware to assert reset circuitry of the system assuming a fault condition.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a first processor for managing a second processor, wherein both processors have access to a same external memory, the method comprising: monitoring performance of the second processor by the first processor running sanity polling, wherein sanity polling includes checking the same external memory for status information of the second processor; performing thread state detection by the first processor, for threads executing on the second processor; and performing a corrective action as a result of either the monitoring or the performing.

Various exemplary embodiments include a first processor for performing a method for managing a second processor, the first processor including, a memory, wherein the second processor also has access to the memory; and the first processor is configured to: monitor performance of the second processor by the first processor running sanity polling, wherein sanity polling includes checking the same external memory for status information of the second processor; perform thread state detection by the first processor, for threads executing on the second processor; and perform a corrective action as a result of either the monitoring or the performing.

### BRIEF DESCRIPTION OF THE DRAWINGS

In order to better understand various exemplary embodiments, reference is made to the accompanying drawings, wherein:

FIG. 1 illustrates an exemplary external software default detection system for distributed multi-CPU architecture;

FIG. 2 illustrates an exemplary multi-threaded operating system user application thread execution state machine;

FIG. 3 illustrates an exemplary method for CPU1 software fault detection on CPU2;

FIG. 4 illustrates an exemplary method for CPU2 software execution fault handling; and

FIG. 5 illustrates exemplary histogram data for threads 1-N.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

The normal flow of software execution on a microprocessor can be disrupted by a number of different factors/failures which can cause a certain piece of code to run endlessly such as in an infinite loop, or cause a crash. This includes but is not limited to software bugs, memory content corruption, or other hardware defects in the system that the software is controlling. Examples of memory content corruption include a soft-error which flips a bit, a software error or a memory scribbler. If the software does not crash due to the fault, often the end result is an endless loop in code which has a detrimental effect on overall software execution. Since software commonly executes over a multi-tasking Operating System (OS) the software may limp along in this state indefinitely.

In this scenario side-effects might include:
Very high Central Processing Unit (CPU) utilization (such as software spinning in a loop) adversely affecting all aspects of the software and its host system and likely starving some functions it provides.
Depending on the task scheduling policy and task/priority involved, the software may become completely unresponsive where it can no longer communicate with the outside world.
The software cannot effectively do its job, and the product fails to operate as expected.

There are also situations where inputs / loading on the software system (for example, network event or configuration scale) lead to software execution abnormalities that result in operational problems; these may be difficult to detect and may cause the same issues as the faults described earlier.

When this happens in a highly available system such as a communications product it may be imperative that there is a means to:

1) Detect the situation and recover the software and operation of the product.

2) Provide visibility of software execution abnormalities (task/thread starvation, deadlocks and CPU hogging) that are impacting the normal/expected behavior of the product.

3) Produce a detailed software back-trace where code is executing in an infinite loop or CPU hogging for debugging. This will either identify a defect in software to be fixed or help isolate the area where software ran into trouble.

Some operating systems may also contain a software version of a watchdog in the kernel but this only provides a means to detect task/thread deadlocks in a software application running over the operating system.

A low-priority idle task may be spawned on the system. The highest priority task, which may be guaranteed to always get processor cycles to run, may periodically check to see that the lowest priority idle task is actually getting processor cycles.

Drawbacks/limitations of these solutions include:
To be truly effective, software watchdogs normally require external hardware support which is designed into the system.
All of the above rely on fault detection mechanisms in the very system that is going faulty, such as self-fault detection.
Unless the endless loop and/or misbehaving code is executing in a high priority task, the watchdog task is likely to preempt and run often enough to prevent a watchdog reset by hardware. In this case adverse effects resulting from the CPU hog may be hidden.
When the idle task is starved all the system may know is some high priority task(s) are hogging the CPU.

Collecting instantaneous or in the last second, CPU utilization for all the threads/tasks running is a common debugging tool provided by most operating systems but does not provide a means to automatically detect abnormalities in real-time, such as starved threads or CPU hogs detected during runtime, by keeping a history of per-thread/task runtime and state information.

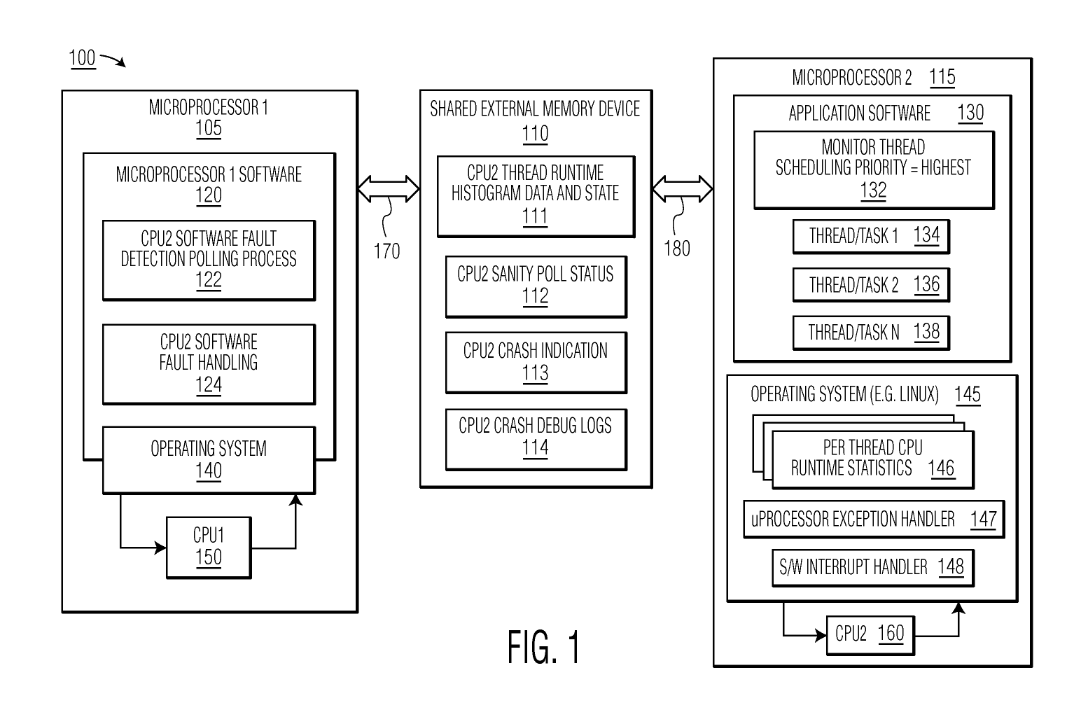

FIG. 1 illustrates an exemplary external software default detection system for distributed multi-CPU architecture 100. Architecture 100 may include microprocessor 1 105, shared external memory device 110, and microprocessor 2 115. Microprocessor 1 105 or microprocessor 2 115 may be a linecard, or a control card, for example. Microprocessor 1 105 may communicate with shared external memory device 110 via memory interface 170. Microprocessor 2 115 may similarly communicate with shared external memory device 110 via memory interface 180.

Microprocessor 1 105, may include microprocessor 1 software 120, operating system 140, and CPU1 150. Microprocessor 1 software 120 may include CPU2 software fault detection polling process 122 and CPU2 software fault handling 124. Shared external memory device 110 may contain CPU2 thread runtime histogram data and state 111, CPU2 sanity poll status 112, CPU2 crash indication 113, and CPU2 crash debug logs 114.

Microprocessor 2 115 may include application software 130, operating system 145, and CPU2 160. Application software 130 may include a high scheduling priority monitor thread 132, thread tasks 1-N 134-138. Operating system 145 may include per thread CPU runtime statistics 146, a microprocessor exception handler 147, and a software interrupt handler 148. Operating system 140 and 145 may be any operating system such as Linux, Windows, ARM.

Embodiments include an external software based solution capable of detecting several types of software execution faults on another CPU. Embodiments of architecture 100 include software embedded in two separate software images executing on two independent CPUs such as CPU1 150 and CPU2 160. Some embodiments include communications products which are architected with software execution distributed across multiple microprocessors. One example includes a system with a main control complex software CPU1 and one or more instances of software executing on linecards, (for example, CPU₂ . . . CPUₙ) housed within a common chassis or motherboard hardware. Shared memory such as when multiple instances of software are running on different physical processors can, read/write from memory mapped device(s) in the system, may provide the only hardware means necessary for an external software fault detection system which may be implemented using shared external memory device 110.

CPU2 160 may periodically store information about its software execution state in shared external memory device 110 to be interpreted by CPU1 150, executing software on an external microprocessor. The information to be interpreted may be divided into 4 sections in the shared memory region including, CPU2 thread runtime histogram data and state 111, CPU2 sanity poll status 112, CPU2 crash indication 113, and CPU2 crash debug logs 114.

CPU2 sanity poll status 112 may include a sanity poll request and/or response block. CPU2 crash debug logs 114 may include a block for crash-debug logging.

CPU2 thread runtime histogram data and state 111 may include a block for per-thread CPU runtime histogram and state information. For example the state may be set to Normal, Watch, Starved, and CPU hog. Similarly timestamp data for state transitions may be stored. In an example, the time when a thread T3 becomes starved and resumes executing normally may be stored. Similarly, information that could be correlated to a system anomaly or failure of the software to operate as expected may also be tracked and stored.

In some embodiments, CPU2 software fault detection polling process may check for software execution anomalies using CPU2 thread runtime histogram data and state 111 via memory interface 170. In some embodiments, CPU2 software fault detection polling process may perform a periodic sanity poll request using CPU2 sanity poll status 112 via memory interface 170. In some embodiments, CPU2 software fault detection polling process 124 may check for a crash indication on CPU2 crash indication 113 when there is no response from CPU2.

When there is no response from microprocessor 2 and no crash indication, CPU2 software fault handling 124 may trigger a software interrupt to software interrupt handler 148. Similarly, CPU2 software fault handling 124 may perform a reboot on CPU2 at the appropriate times.

High scheduling priority monitor thread 132, may send per thread runtime histogram and state information updates to CPU2 thread runtime histogram data and state 111 High scheduling priority monitor thread 132 may also periodically collect thread runtime data from the kernel per thread CPU runtime statistics 146. Similarly, thread/task 1 may send a sanity poll response to CPU2 sanity poll status 112. Microprocessor exception handler 147 may store CPU2 crash indication and debug logs on either CPU2 crash indication 113 or CPU2 crash debug logs 114.

CPU2 will periodically collect all thread/task runtime data for thread/tasks 1-N 134-138 from the kernel by means of a periodic high scheduling priority monitor thread 132. CPU2 may use data to maintain a runtime histogram and as input to a per-thread state machine.

A simple periodic sanity test message may be sent/acknowledged between CPU1 and CPU2 via the shared external memory device 110. The sanity test message response on CPU2 may be hooked into the thread/task 1-N 134-138 with the highest scheduling priority to guarantee timely response to CPU1 in CPU2 software fault detection polling process 122. For example, when CPU2 fails to respond to CPU1 after a pre-determined timeout value such as 5 seconds, then there may be a software fault that requires further actions.

CPU1 may detect/alarm software execution abnormalities by examining the thread runtime histogram and current state of each thread in the shared external memory device 110. CPU2 may also provide a software stacktrace of the thread on the system that is consuming the most CPU runtime when things go awry to provide visibility/isolation of the software fault

When CPU2 crashes, it may store a code in the shared memory block and copy all relevant debug data from microprocessor exception handler 147. This is similar to the software crash “black-box” for CPU2 accessible by CPU1, no matter what happens to the hardware where CPU2 was running.

CPU1 may check if CPU2 crashed, for example a microprocessor exception occurred such as divide by zero. CPU1 may check if CPU2 crashed by checking for a crash-code in the shared external memory device 110.

When CPU2 crashed, microprocessor 1 105 may collect debug information stored by CPU2 in shared memory and reboot CPU2.

When CPU2 did not crash and still is not responding a few things may have occurred:
CPU2 has run into a task scheduling problem and T1 is not getting CPU cycles to respond to CPU1 Trigger a software interrupt on CPU2 using CPU2 software fault handling 124. CPU2 may respond via software interrupt handler 148, by storing complete per-thread stacktraces to the shared external memory device 110 in CPU2 crash debug logs 114, to be used to root cause the fault, then wait to be rebooted by CPU1.
The hardware has failed, CPU2 is Hung. Instantiate a reboot of CPU2 or a recovery attempt, and raise an alarm using CPU2 software fault detection polling process 124.

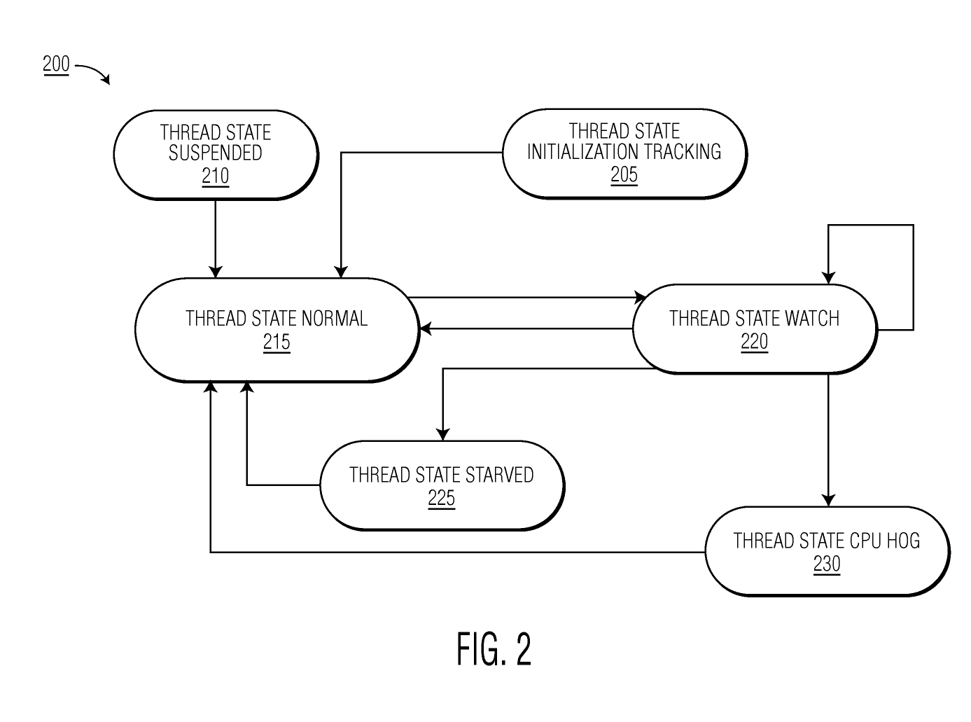

FIG. 2 illustrates an exemplary multi-threaded operating system user application thread execution state machine 200. State machine 200 may include thread state initialization tracking 205, thread state suspended 210, thread state normal 215, thread state watch 220, thread state starved 225, and thread state CPU hog 230. Application software 130 executing on CPU2 160 may maintain state machine 200 for each thread 1-N.

When a thread is created in application software 130, it will default to the thread initialization tracking state 205. The tracking state may ensure enough samples of runtime data have been collected in a histogram to establish ‘normal’ execution patterns for each thread. This allows software to detect abnormalities from the point forward. The thread state may transition to thread state normal 215 after four minutes have elapsed, for example.

Thread state suspended 210 may be used manually when a thread has been suspended. When the thread has resumed it may move from thread state suspended 210 to thread state normal 215.

Thread state normal 215 may be moved to from thread state watch 220 when the CPU runtime in the last poll is back in ‘normal range’ based on histogram data for the thread.

Thread state normal 215 may similarly be moved to from thread state starved 225, when the CPU runtime in the last 3 consecutive polls inidicate back in “normal range” based on the histogram data for the thread.

Thread state normal 215 may similarly be moved to from thread state CPU hog 230 when the CPU runtime for the last three consecutive polls indicate back in the ‘normal range’ based on histogram data for this thread.

Thread state watch 220 may raise a warning alarm and move to thread state starved 225 when the CPU runtime=0%, and the normal range is greater than 0%, and the starvation threshold=N consecutive polls reached. Thread state watch 220 may similarly raise a warning alarm and move to thread state CPU hog 230 when the CPU runtime is greater than 90% and the CPU hog threshold=X polls reached with thread not returning to ‘normal range.’ Thread state watch 220 may similarly maintain its state when the CPU runtime in the last poll=‘normal range’ based on histogram data for this thread & threshold X or N if not reached.

When in thread state starved 225, CPU2 may attach and invoke stack traces of all thread/tasks 1-N 134-138 and identify CPU hog(s) causing thread state starved.

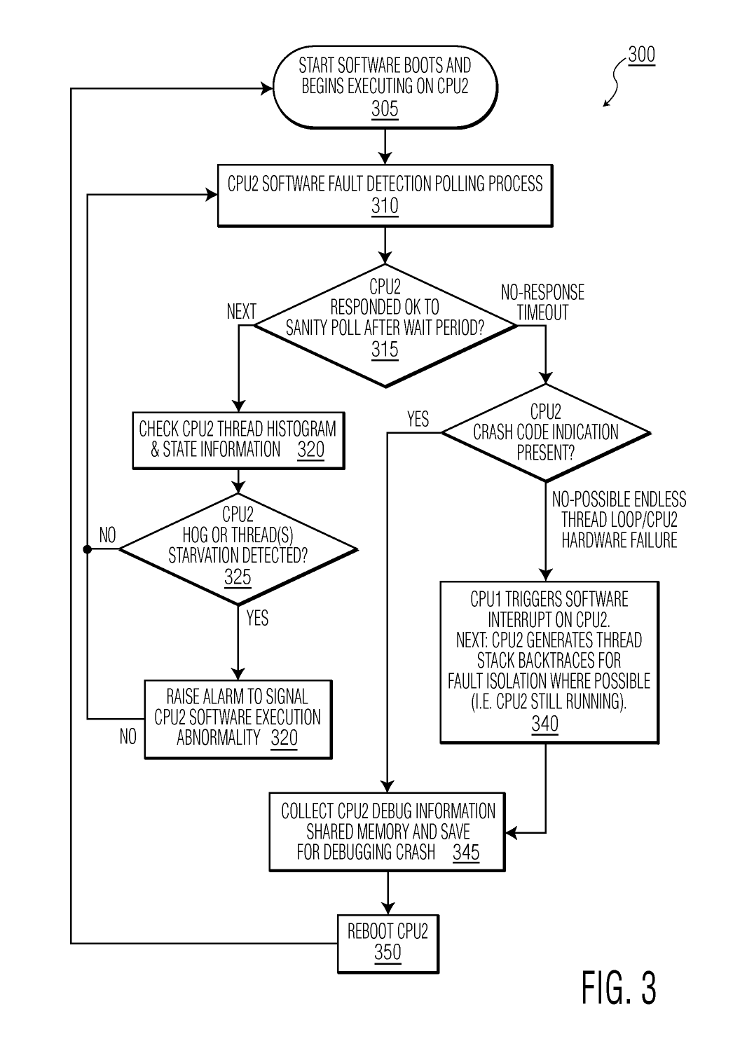

FIG. 3 illustrates an exemplary method for CPU1 software fault detection on CPU2 300. CPU2 may start in step 305. In step 305 the software may bootup and begin executing on CPU2. CPU1 may move to step 310 and begin monitoring CPU2 once it is started up.

In step 310, CPU2 software fault detection polling process may take place. For example, CPU1 may poll every 1 second. CPU1 may proceed to step 315 where it may check if CPU2 responded ok to the sanity poll after the wait period. When CPU2 did respond ok to the sanity poll, CPU1 may proceed to step 320, otherwise it will proceed to step 335.

In step 320, the method may check the CPU2 thread histogram and state information. When done, the method may proceed to step 325. In step 325, the method may determine whether any thread(s) starvation or CPU hogging state was detected on CPU2. When CPU hogging or thread starvation was detected, the method may proceed to step 330. When CPU hogging or thread starvation was not detected, the method may proceed to step 310 where it will continue to poll. In step 330, the method may raise an alarm to signal a CPU2 software execution abnormality

In step 335, the method may determine whether a CPU2 crash code indication is present. When the CPU2 crash code indication is present, the method may proceed to step 345. When the CPU2 crash code indication is not present, the method may determine if a possible endless thread loop or CPU2 hardware failure occurred and proceed to step 340.

In step 340, CPU1 may trigger a software interrupt on CPU2. Subsequently, if hardware has not failed CPU2 may generate thread stack backtraces for fault isolation where possible. Next, the method may proceed to step 345.

In step 345, the method may collect CPU2 debug information from shared external memory device 110 and save the information for debugging a crash. From step 345, the method may proceed to step 350 where the method may reboot CPU2. The method may then return to step 305 to begin the process again.

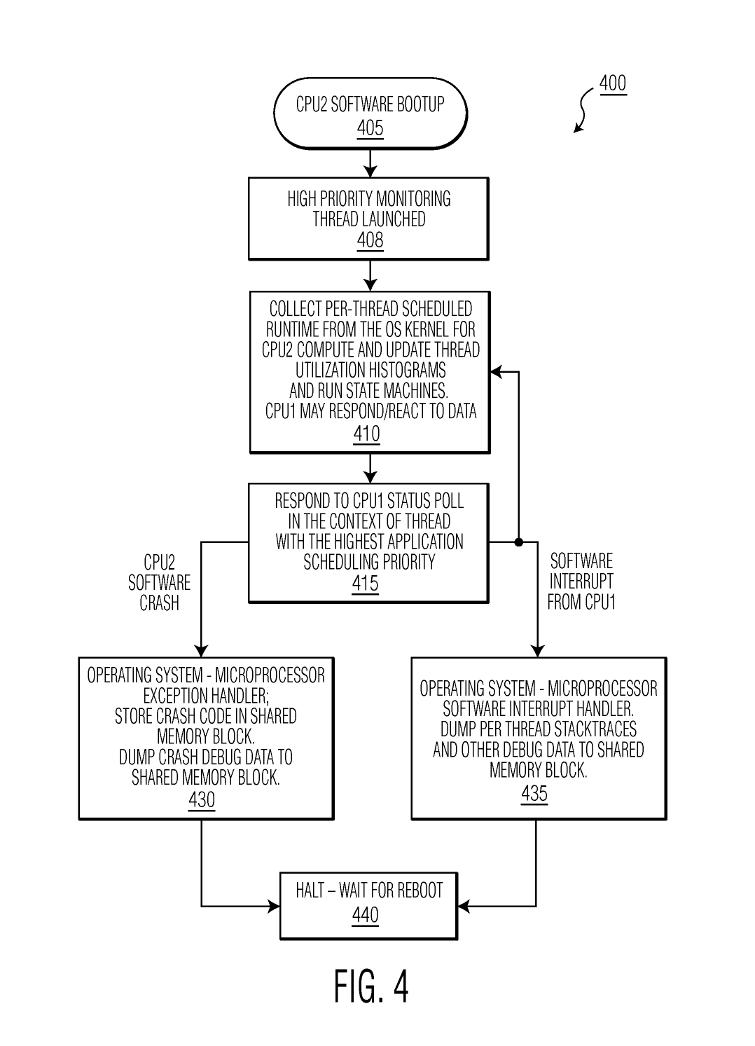

FIG. 4 illustrates an exemplary method for CPU2 software execution fault handling 400.

Method 400 may begin in step 405 when application software has booted on CPU2. Method 400 may proceed to step 408 where a high priority monitoring thread may be launched. Method 400 may proceed to step 410.

In step 410, the method may collect per-thread scheduled runtime from the OS kernel for CPU2 from the high priority monitoring thread created in 405. The method may also compute and update thread utilization histograms and run state machines from FIG. 2. CPU1 may respond and/or react to data in this step. Periodic polling may similarly occur in step 410. The method may then move forward to step 415.

In step 415, the method may respond to a CPU1 status poll in the context of a thread with the highest application scheduling priority. Step 415 may return to step 410 to continue monitoring. The method may continue to step 430 when there is a CPU2 software crash. Similarly, the method may continue to step 435 when there is a software interrupt from CPU1.

In step 430, the operating system microprocessor exception handler may be executed by CPU2. The handler may store a crash code in shared memory block. Similarly, the handler may dump crash debug data to shared memory block. Method 400 may then proceed to step 440 where it may halt and wait for a reboot.

In step 435 the operating system microprocessor software interrupt handler may similarly execute on CPU2. For example, the handler may perform a dump of per thread stacktraces and other debug data to shared memory block. Method 400 may then proceed to step 440 where it may halt and wait for a reboot.

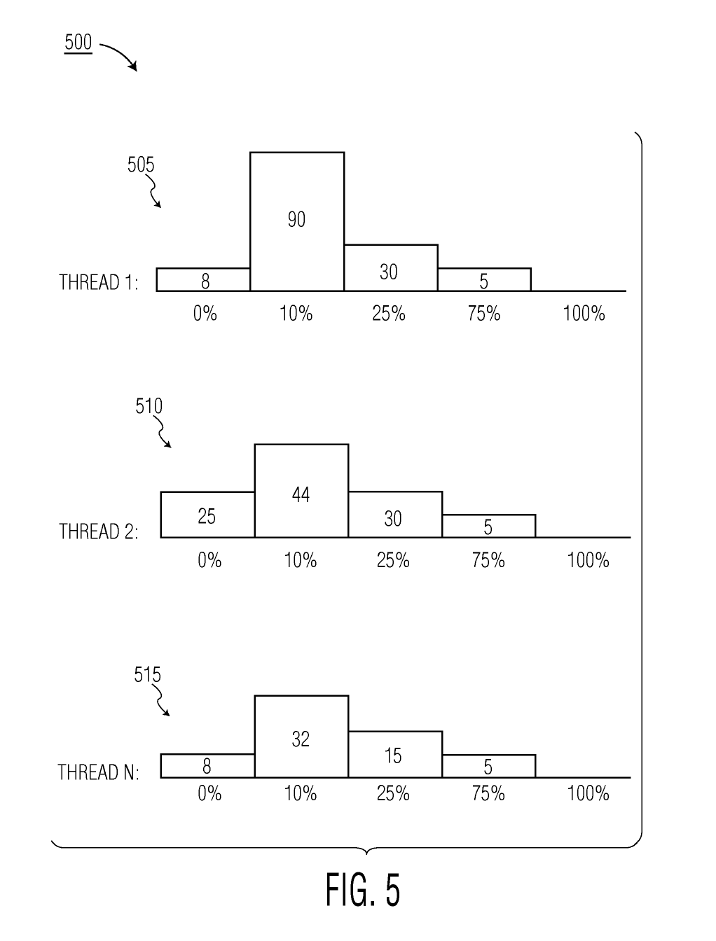

FIG. 5 illustrates exemplary histograms with data for threads 1-N 500. Exemplary histograms 500 includes thread 1 histogram 505, thread 2 histogram 510, and thread N histogram 515. This data can be used later on during polling and analysis to determine if CPU2 software is executing outside of ordinary conditions. For example, if CPU1 determines that one of the threads is currently processing at 90% utilization, while it normally processes at 10%, this may indicate that a problem exists. CPU1 may kill the misbehaving thread or reset CPU2

In thread 1 histogram 505, 8+90+30+5=133 represents the total number of samples, or polls that software did to the operating system, to get the CPU runtime for Thread 1 following a fixed interval of, for example, 1 second. Thread 1 had 0% runtime in 8 polls, 10% runtime in 90 polls, 25% runtime in 30 polls, and 75% runtime in 5 polls.

In another example a software application has three threads T1/T2/T3 running over an operating system such as Linux. Every second, the software may poll the operating system for the total runtime (which may be measured in CPU ticks) which each thread T1-T3, had in the last one second interval. Using this data, the % CPU for each thread may be computed and a corresponding statistic (bucket for each CPU utilization band) is incremented in the histogram.

Over a period of time, including repeated polls, a pattern of execution on the CPU for each thread relative to one another may emerge by viewing the histogram data. This data should not be interpreted until the software system has been running for a reasonable duration. This may be stored in thread state initialization tracking 205.

In one example:

Poll #440 may return: T1=50, T2=35, T3=15. Total CPU ticks=50+35+15=100 in this interval which means T1-T3 had 50% 35% and 15% of CPU runtime respectively.

Histogram statistics collected thus far may be as follows:

[Thread Runtime Histogram-pollCount = 440]

| | %: | | | | | | | |
|---|---|---|---|---|---|---|---|---|
| | 0 | 10 | 25 | 50 | 75 | 90 | 100 | <<<Current State>>> |
| T1 | 0 | 2 | 5 | 244 | 188 | 0 | 0 | Last: 50%/NORMAL |
| | | | | | | | | (Starved = 0 CPUHog = 0) |
| T2 | 6 | 85 | 329 | 19 | 0 | 0 | 0 | Last: 35%/NORMAL |
| | | | | | | | | (Starved = 0 CPUHog = 0) |
| T3 | 54 | 361 | 16 | 1 | 5 | 1 | 1 | Last: 15%/NORMAL |
| | | | | | | | | (Starved = 0 CPUHog = 0) |

Poll #441 may return: T1=55, T2=40, T3=5. Total ticks=100 in this interval which means T1-T3 had 55% 40% and 5% of CPU runtime respectively. The underlined statistics may be incremented.

[Thread Runtime Histogram-pollCount = 441]

| | %: | | | | | | | |
|---|---|---|---|---|---|---|---|---|
| | 0 | 10 | 25 | 50 | 75 | 90 | 100 | <<<Current State>>> |
| T1 | 0 | 2 | 5 | 244 | 189 | 0 | 0 | Last: 55%/NORMAL |
| | | | | | | | | (Starved = 0 CPUHog = 0) |
| T2 | 6 | 85 | 329 | 20 | 0 | 0 | 0 | Last: 40%/NORMAL |
| | | | | | | | | (Starved = 0 CPUHog = 0) |
| T3 | 54 | 362 | 16 | 1 | 5 | 1 | 1 | Last: 5%/NORMAL |
| | | | | | | | | (Starved = 0 CPUHog = 0) |

The data above may illustrate that T1 normally gets 50-75% of CPU runtime for all threads, therefore supposing the next few polls show T1 runtime=0% then one can conclude that something is incorrect with the “normal” execution of software. T1 may be starved and it is likely that T2 or T3 are responsible. Tracing on T2 and T3 in the scenario may help root cause the reason T1 is starved.

One may also see that T3 normally gets very little CPU (<=10%) relative to T1 and T2 but occasionally gets very busy and consumes>90% of the total thread CPU runtime for a short duration. Provided T3 doesn't run @>90% for an extended period of time (CPU hog) then this is also considered “Normal”.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a first processor for managing a second processor, wherein both processors have access to a same external memory, the method comprising:
monitoring performance of the second processor by the first processor running sanity polling, wherein sanity polling includes checking the same external memory for status information of the second processor;
performing thread state detection by the first processor, for threads executing on the second processor; and
performing a corrective action as a result of either the monitoring or the performing.

2. The method of claim 1, wherein the thread state detection includes checking a histogram for a thread being executed on the second processor to determine whether the thread is operating normally.

3. The method of claim 2, wherein the histogram is generated by the first processor collecting information from the second processor periodically and storing the information as a histogram.

4. The method of claim 3, wherein the performing a corrective action includes:
when the histogram data indicates that the thread is executing abnormally, performing a recovery on the second processor, by forcing the second processor to reboot.

5. The method of claim 3, wherein the performing a corrective action includes:
interrupting the second processor and determining what is causing a fault.

6. The method of claim 1, wherein the monitoring includes:
checking the external memory for a crash code;
signaling an interrupt to the second processor;
causing the second processor to dump all its thread and stack information onto the external memory; and
interpreting by the first processor the thread and stack information from the external memory.

7. The method of claim 6, wherein the method further comprises:
causing the second processor to dump a crash log after the interrupt was signaled, the crash log to be used for debugging.

8. The method of claim 1, wherein the second processor's status information includes an indication that the hardware is stuck and unresponsive due to thread(s) running in an endless loop.

9. The method of claim 1, wherein the second processor's status information includes an indication that the hardware is unresponsive due to a hung microprocessor.

10. A first processor for performing a method for managing a second processor, the first processor comprising:
a memory, wherein the second processor also has access to the memory; and
the first processor is configured to:
monitor performance of the second processor by the first processor running sanity polling, wherein sanity polling includes checking the same external memory for status information of the second processor;
perform thread state detection by the first processor, for threads executing on the second processor; and
perform a corrective action as a result of either the monitoring or the performing.

11. The first processor of claim 10, wherein the first processor is further configured to:
check a histogram for a thread being executed on the second processor to determine whether the thread is operating normally.

12. The first processor of claim 11, wherein the histogram is generated by the first processor collecting information from the second processor periodically and storing the information as a histogram.

13. The first processor of claim 12, wherein in performing a corrective action, the first processor is further configured to:
when the histogram data indicates that the thread is executing abnormally, perform a recovery on the second processor, by forcing the second processor to reboot.

14. The first processor of claim 12, wherein in performing a corrective action, the first processor is further configured to:
interrupt the second processor and determine what is causing a fault.

15. The first processor of claim 10, wherein in monitoring, the first processor is further configured to:
check the external memory for a crash code;
signal an interrupt to the second processor;
cause the second processor to dump all its thread and stack information onto the external memory; and
interpret by the first processor the thread and stack information from the external memory.

16. The first processor of claim 15, wherein the first processor is further configured to:
cause the second processor to dump a crash log after the interrupt was signaled, the crash log to be used for debugging.

17. The first processor of claim 10, wherein the second processor's status information includes an indication that the hardware is stuck and unresponsive due to thread(s) running in an endless loop.

18. The first processor of claim 10, wherein the second processor's status information includes an indication that the hardware is unresponsive due to a hung microprocessor.
